(19) United States
(12) Patent Application Publication
(10) Pub. No.: US 2021/0308733 A1
(43) Pub. Date: Oct. 7, 2021

(54) METHOD OF ASSEMBLING AN ELECTROCALORIC ARTICLE AND ELECTROCALORIC HEAT TRANSFER SYSTEM

(71) Applicant: CARRIER CORPORATION, Palm Beach Gardens, FL (US)

(72) Inventors: Subramanyaravi Annapragada, South Windsor, CT (US); Scott Alan Eastman, Glastonbury, CT (US); Joseph V. Mantese, Ellington, CT (US); Wei Xie, Malden, MA (US); Wayde R. Schmidt, Pomfret Center, CT (US); Craig R. Walker, South Glastonbury, CT (US); Sameh Dardona, South Windsor, CT (US); Slade R. Culp, Coventry, CT (US)

(21) Appl. No.: 17/058,264

(22) PCT Filed: Aug. 23, 2019
(86) PCT No.: PCT/US2019/047962

§ 371 Date: Nov. 24, 2020

Related U.S. Application Data
(60) Provisional application No. 62/722,736, filed on Aug. 24, 2018.

(51) Int. Cl. B21D 5/01; F25B 21/00; B23P 15/26

(52) U.S. Cl. CPC B21D 5/01; F25B 2321/001; B23P 15/26; F25B 21/00

(57) ABSTRACT

A method of making an electrocaloric article is disclosed in which a continuous sheet of an electrocaloric film is bent back and forth to form a plurality of connected aligned segments of electrocaloric film with gaps between film surfaces of adjacent aligned segments. The continuous sheet of electrocaloric film is secured in this with a securing method that includes attaching a spacer to the continuous sheet of electrocaloric film prior to the back and forth bending; or providing a spacer comprising a base and a plurality of projections extending from the base, and inserting the projections into the gaps between the film surfaces of adjacent aligned segments after the back and forth bending; or interweaving a continuous spacer through the gaps between the aligned segments of the electrocaloric film; or attaching an end cap to a plurality of connecting portions of the electrocaloric film between the aligned segments.

### BACKGROUND

A wide variety of technologies exist for cooling applications, including but not limited to evaporative cooling, convective cooling, or solid state cooling such as electrothermic cooling. One of the most prevalent technologies in use for residential and commercial refrigeration and air conditioning is the vapor compression refrigerant heat transfer loop. These loops typically circulate a refrigerant having appropriate thermodynamic properties through a loop that includes a compressor, a heat rejection heat exchanger (i.e., heat exchanger condenser), an expansion device and a heat absorption heat exchanger (i.e., heat exchanger evaporator). Vapor compression refrigerant loops effectively provide cooling and refrigeration in a variety of settings, and in some situations can be run in reverse as a heat pump. However, many of the refrigerants can present environmental hazards such as ozone depleting potential (ODP) or global warming potential (GWP) or can be toxic or flammable. Additionally, vapor compression refrigerant loops can be impractical or disadvantageous in environments lacking a ready source of power sufficient to drive the mechanical compressor in the refrigerant loop. For example, in an electric vehicle, the power demand of an air conditioning compressor can result in a significantly shortened vehicle battery life or driving range. Similarly, the weight and power requirements of the compressor can be problematic in various portable cooling applications.

Accordingly, there has been interest in developing cooling technologies as alternatives to vapor compression refrigerant loops. Various technologies have been proposed such as field-active heat or electric current-responsive heat transfer systems relying on materials such as electrocaloric materials, magnetocaloric materials, or thermoelectric materials. However, many proposals have been configured as bench-scale demonstrations with limited capabilities.

### BRIEF DESCRIPTION

A method of making an electrocaloric article is disclosed. According to the method, a continuous sheet of an electrocaloric film is bent back and forth to form a plurality of connected aligned segments of electrocaloric film in a configuration that includes gaps between film surfaces of adjacent aligned segments. The continuous sheet of electrocaloric film is secured in the configuration of connected aligned segments including gaps between film surfaces of adjacent aligned segments with a securing method. The securing method includes any one or combination of attaching a spacer to the continuous sheet of electrocaloric film prior to the back and forth bending; or providing a spacer comprising a base and a plurality of projections extending from the base, and inserting the projections into the gaps between the film surfaces of adjacent aligned segments after the back and forth bending; or interweaving a continuous spacer through the gaps between the aligned segments of the electrocaloric film; or attaching an end cap to a plurality of connecting portions of the electrocaloric film between the aligned segments.

In some embodiments, the securing method includes attaching the spacer to the continuous sheet of electrocaloric film prior to the back and forth bending.

In some embodiments, the securing method can include dispensing the continuous sheet of electrocaloric film from a roll of electrocaloric film and attaching the spacer to the dispensed electrocaloric film prior to the back and forth bending.

In any one or combination of the foregoing embodiments, the spacer can be attached to the electrocaloric film by punching or bonding.

In any one or combination of the foregoing embodiments, the securing method can include attaching the plurality of spacers to the continuous sheet of electrocaloric film prior to the back and forth bending.

In any one or combination of the foregoing embodiments, the securing method can include providing a spacer comprising a base and a plurality of projections extending from the base and inserting the projections into the gaps between the film surfaces of adjacent aligned segments after the back and forth bending.

In any one or combination of the foregoing embodiments, the securing method can include inserting the projections of a plurality of spacers comprising a base and a plurality of projections into the gaps at a plurality of locations between the film surfaces of adjacent aligned segments after the back and forth bending.

In any one or combination of the foregoing embodiments, the securing method can include inserting the projections of a first spacer into the gaps at a first location between the film surfaces at a first edge of a plurality of adjacent aligned segments, inserting the projections of a second spacer into the gaps at a second location between the film surfaces at a second edge of a plurality of adjacent aligned segments opposite the first edge, and engaging the projections of the first and second spacer structures.

In any one or combination of the foregoing embodiments, the securing method includes interweaving a continuous spacer through the gaps between the aligned segments of the electrocaloric film.

In any one or combination of the foregoing embodiments, the continuous spacer can comprise directing the continuous spacer back and forth across a width of the aligned segments in a direction different than a direction of extension of the continuous sheet of electrocaloric film.

In any one or combination of the foregoing embodiments, the securing method can include attaching an end cap to a plurality of connecting portions of the electrocaloric film between the aligned segments.

In any one or combination of the foregoing embodiments, the end cap can be electrically conductive and electrically connected to an electrode on the electrocaloric film.

In any one or combination of the foregoing embodiments, attaching the end cap to the plurality of connecting portions of the electrocaloric film can include fusing, potting, or molding the end cap to the electrocaloric film.

In any one or combination of the foregoing embodiments, the spacer can be electrically non-conductive.

In any one or combination of the foregoing embodiments except for the immediately preceding embodiment, the spacer can be electrically conductive.

In any one or combination of the foregoing embodiments, the method can further include connecting an electrode or electrodes on the electrocaloric film to a power control circuit.

In any one or combination of the foregoing embodiments, the spacer can be electrically conductive and electrically connected to the electrode and the power control circuit.

In any one or combination of the foregoing embodiments, the electrode or the electrically-conductive spacer can be electrically connected to the power control circuit through an electrical bus.

In any one or combination of the foregoing embodiments, the bending of the continuous sheet of electrocaloric film can impart the configuration of connected aligned segments with alternating large and small gaps.

In any one or combination of the foregoing embodiments, the method can further include disposing a support in the small gaps.

In any one or combination of the foregoing embodiments, bending the continuous sheet of electrocaloric film can include engaging the electrocaloric film with a supporting structure to position or maintain the electrocaloric film in the configuration comprising aligned segments, and wherein the electrocaloric film is disengaged from the supporting structure after performing the securing method.

In any one or combination of the foregoing embodiments, the method can further include pre-folding the electrocaloric film prior to bending back and forth to form the plurality of connected aligned segments.

A heat transfer system is also disclosed, including a plurality of supported electrocaloric film segments arranged and secured in a stack, which can be prepared according to the method of any one or combination of foregoing embodiments. A working fluid flow path extends through the stack, disposed in gaps between adjacent aligned electrocaloric film segments. The working fluid flow path is in operative thermal communication with a heat sink and a heat source at opposite ends of the working fluid flow path. A plurality of electrodes are arranged to generate an electric field in the electrocaloric film segments, and are connected to a power source configured to selectively apply voltage to activate the electrodes in coordination with fluid flow along the working fluid flow path to transfer heat from the heat source to the heat sink.

### BRIEF DESCRIPTION OF THE DRAWINGS

The following descriptions should not be considered limiting in any way. With reference to the accompanying drawings, like elements are numbered alike:

FIG. 1 schematically shows an electrocaloric article with a plurality of connected aligned segments of electrocaloric film;

FIG. 2 schematically shows attachment of a spacer in a film roll processing operation;

FIGS. 3A, 3B, and 3C each schematically shows an example embodiment of a back and forth bending sheet processing operation;

FIG. 4 schematically shows an electrocaloric article with a plurality of connected aligned segments of electrocaloric film held in place by a supporting structure;

FIGS. 5A and 5B each schematically shows introduction of a spacer into an electrocaloric article with a plurality of connected aligned segments of electrocaloric film;

FIGS. 6A and 6B each schematically shows introduction of multiple spacers into an electrocaloric article with a plurality of connected aligned segments of electrocaloric film;

FIGS. 7A and 7B each schematically shows interweaving a continuous spacer into an electrocaloric article with a plurality of connected aligned segments of electrocaloric film;

FIGS. 8A, 8B, 8C, and 8D schematically show fabrication of an electrocaloric article with a plurality of connected aligned segments of electrocaloric film by weaving of a continuous film;

FIGS. 9A, 9B, 9C, and 9D schematically show fabrication of an electrocaloric article with a plurality of connected aligned segments according to FIG. 1; and

FIG. 10 is a schematic depiction of an example embodiment of an electrocaloric heat transfer system.

### DETAILED DESCRIPTION

A detailed description of one or more embodiments of the disclosed apparatus and method are presented herein by way of exemplification and not limitation with reference to the Figures.

As mentioned above, electrocaloric articles are disclosed that include adjacent aligned segments of a continuous sheet of electrocaloric film. An example embodiment of such an article 10 with segments in a stack-like configuration is schematically shown in FIG. 1. As shown in FIG. 1, an electrocaloric film 12 comprises an electrocaloric polymer film 14 with a first electrode 16 on a first side of the film and a second electrode 18 on a second side of the film. Examples of electrocaloric polymer materials for the electrocaloric polymer film 14 can include but are not limited to ferroelectric polymers, liquid crystal polymers, and liquid crystal elastomers. Ferroelectric polymers are crystalline polymers, or polymers with a high degree of crystallinity, where the crystalline alignment of polymer chains into lamellae and/or spherulite structures can be modified by application of an electric field. Such characteristics can be provided by polar structures integrated into the polymer backbone or appended to the polymer backbone with a fixed orientation to the backbone. Examples of ferroelectric polymers include polyvinylidene fluoride (PVDF), polytriethylene fluoride, odd-numbered nylon, copolymers containing repeat units derived from vinylidene fluoride, and copolymers containing repeat units derived from triethylene fluoride. Polyvinylidene fluoride and copolymers containing repeat units derived from vinylidene fluoride have been widely studied for their ferroelectric and electrocaloric properties. Examples of vinylidene fluoride-containing copolymers include copolymers with methyl methacrylate, and copolymers with one or more halogenated co-monomers including but not limited to trifluoroethylene, tetrafluoroethylene, chlorotrifluoroethylene, trichloroethylene, vinylidene chloride, vinyl chloride, and other halogenated unsaturated monomers. In some embodiments, the electrocaloric film can include a polymer composition according to WO 2018/004518 A1 or WO 2018/004520 A1, the disclosures of which are incorporated herein by reference in their entirety.

Liquid crystal polymers, or polymer liquid crystals comprise polymer molecules that include mesogenic groups. Mesogenic molecular structures are well-known and are often described as rod-like or disk-like molecular structures having electron density orientations that produce a dipole moment in response to an external field such as an external electric field. Liquid crystal polymers typically comprise numerous mesogenic groups connected by non-mesogenic molecular structures. The non-mesogenic connecting structures and their connection, placement and spacing in the polymer molecule along with mesogenic structures are important in providing the fluid deformable response to the external field. Typically, the connecting structures provide stiffness low enough so that molecular realignment is induced by application of the external field, and high enough to provide the characteristics of a polymer when the external field is not applied. In some exemplary embodiments, a liquid crystal polymer can have rod-like mesogenic structures in the polymer backbone separated by non-mesogenic spacer groups having flexibility to allow for re-ordering of the mesogenic groups in response to an external field. Such polymers are also known as main-chain liquid crystal polymers. In some exemplary embodiments, a liquid crystal polymer can have rod-like mesogenic structures attached as side groups attached to the polymer backbone. Such polymers are also known as side-chain liquid crystal polymers.

The electrodes 16 and 18 on the electrocaloric film can take different forms with various electrically conductive components. The electrodes can be any type of conductive material, including but not limited to metallized layers of a conductive metal such as aluminum or copper, or other conductive materials such as carbon (e.g., carbon nanotubes, graphene, or other conductive carbon). Noble metals can also be used but are not required. Other conductive materials such as a doped semiconductor, ceramic, or polymer, or conductive polymers can also be used. In some embodiments, the electrodes can be in the form of metalized layers or patterns on each side of the film such as disclosed in published PCT application WO 2017/111921 A1 or U.S. patent application 62/521,080, the disclosures of each of which is incorporated herein by reference in its entirety.

With continued reference now to FIG. 1, a continuous sheet of the electrocaloric film 12 is shown folded back and forth to provide a plurality of connected aligned segments 20 arranged in a stack-like configuration with gaps 22 between the electrocaloric film segments 20. The gaps 22 can provide a flow path in a direction into or out of the page for a working fluid such as air or a heat transfer fluid. The gaps 22 between the electrocaloric film are maintained by spacers 24 disposed in the gaps 22 between the aligned electrocaloric film segments 20. An electrical bus end cap 26 provides an electrical connection to the electrode 18. In some embodiments, the electrodes can be connected to a power control circuit (not shown). In some embodiments, the electrode 18 can be connected to a voltage ground and the electrode 16 can be connected to a non-ground voltage. Variations can of course be made on this design. For example, FIG. 1 shows the electrodes 16 and 18 extending continuously along the continuous sheet of electrocaloric film 12, which allows for a direct electrical connection to the electrical bus end caps 26/28. However, the metalized layers for the electrodes 16/18 can also be discontinuous, with electrical connections being provided through the spacers 24 or by one or more separate electrical leads extending through an external frame (not shown). Discontinuous metalized layers can be used, for example, in combination with separate electrical connections to a power circuit (not shown) to allow for individual control or activation of any one or combination of the segments 20 of the electrocaloric film.

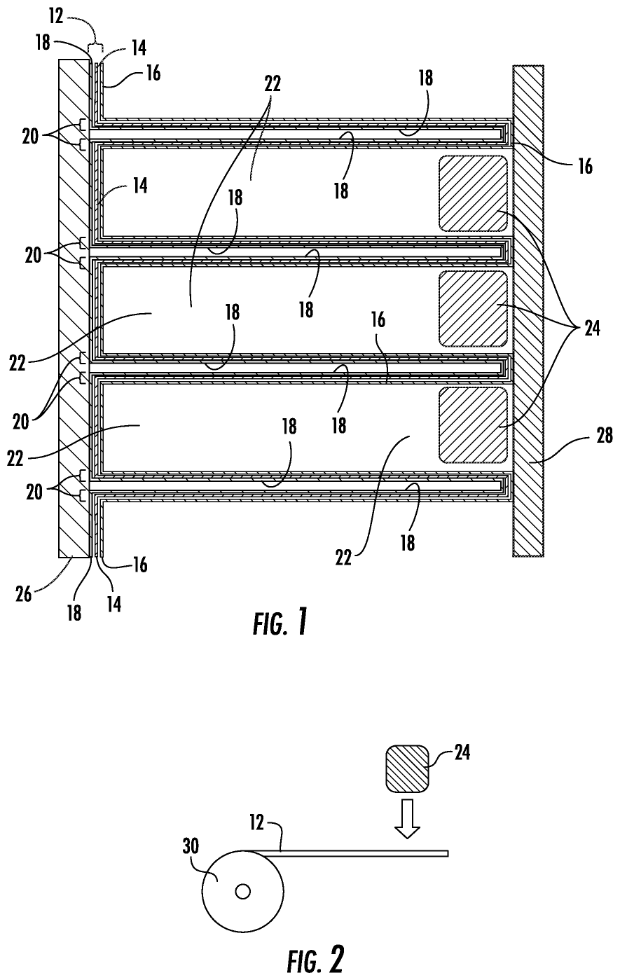

As mentioned above, in some embodiments, the electrocaloric film can be secured in a configuration of aligned connected segments by attaching a spacer to a continuous sheet of electrocaloric film prior to bending of the sheet back and forth. An example embodiment of such an attachment technique is schematically shown in FIG. 2. As shown in FIG. 2, a continuous sheet of electrocaloric film 12 is dispensed from a roll 30, and spacer 24 is attached to the dispensed electrocaloric film 12 before bending of the electrocaloric film into a back and forth configuration of aligned connected segments 20 (FIG. 1). Attachment of the spacer can be carried out by various known techniques including but not limited to attachment with an adhesive (e.g., acrylic, epoxy, polyurethane), punching (in which a projection on the spacer 24 (not shown) is engaged with an opening in the electrocaloric film 12 that can be formed by punching the film with a tool or the spacer projection), taping, welding (e.g., ultrasonic welding), etc.

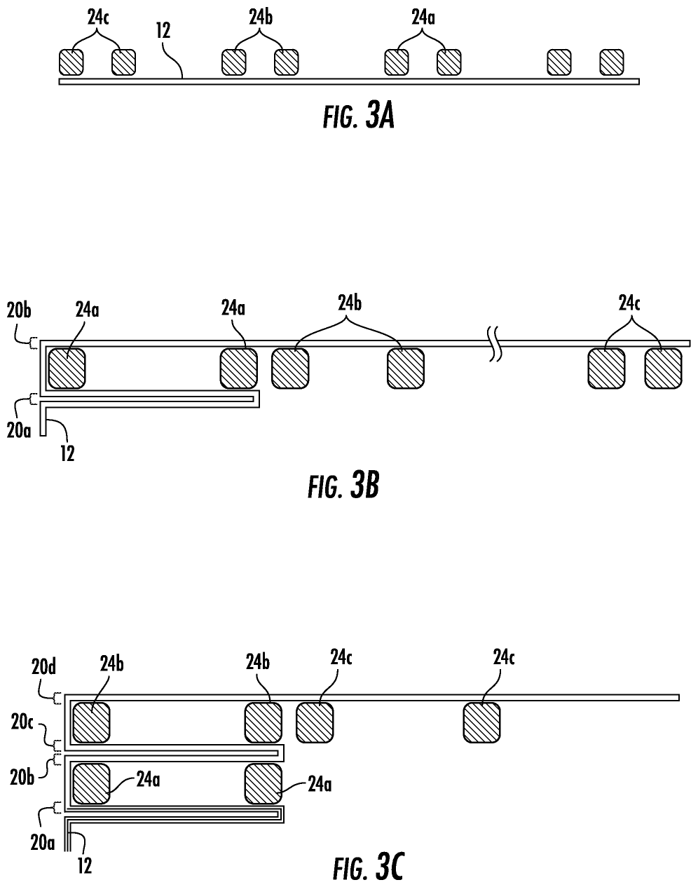

An example embodiment showing bending of an electrocaloric film 12 with spacers 24 attached thereto (e.g., attached as part of a roll processing operation as shown in the example embodiment of FIG. 2), is schematically shown in FIGS. 3A-3D. FIG. 3A schematically shows a continuous sheet of electrocaloric film 12 with spacers 24 (i.e., 24a, 24b, 24c) attached thereto. The sheet is shown as a discrete article; however, in practice the skilled person will appreciate that the sheet can be processed as a leading edge of a roll continuously dispensed by an apparatus such as shown in FIG. 2. Also, although not shown, the sheet may be supported by a support film, belt, or other structure and/or engaged by tooling (e.g., automated folding arms that grab and fold a continuously dispensed film). In FIG. 3B, the sheet of electrocaloric film 12 has been folded back on itself to form a first course of a stack-like structure of film segments 20a and 20b separated by spacers 24a. In some embodiments, the folds can be made along pre-made fold lines (e.g., pre-made as part of a roll processing operation). Additional attachment of the spacers 24 to the electrocaloric film 12 (e.g., attachment of the spacers 24a to the electrocaloric film segment 20b, attachment to the segment 20a having been made as shown in FIG. 3A) can be made during these operations using attachment techniques such as adhesive, ultrasonic welding, or simple friction. In FIG. 3C, another sheet of electrocaloric film 12 has been folded back on itself to form a second course of a stack-like structure of film segments 20b and 20c separated by spacers 24b. In FIG. 3D, another sheet of electrocaloric film 12 has been folded back on itself to form a third course of a stack-like structure of film segments 20c and 20d separated by spacers 24c.

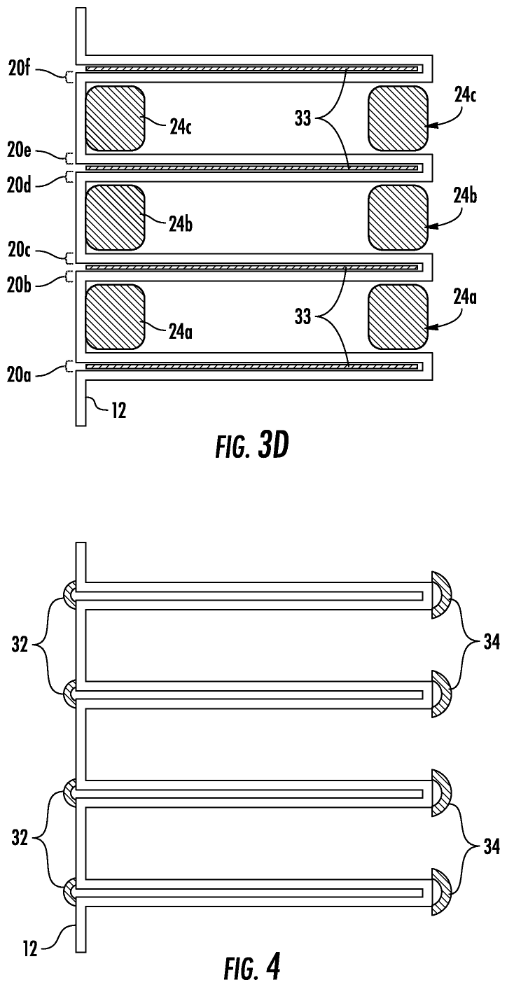

The assembly operation shown in FIGS. 3A-3D utilized the spacers 24 as part of a supporting structure in forming a stack-like configuration. However, in some embodiments, the spacers 24 can be inserted after bending the continuous sheet of electrocaloric film back and forth into a stack-like configuration. In these and other embodiments, the bent or folded electrocaloric film can be temporarily secured in place by a supporting structure. As shown in FIG. 4, the electrocaloric film 12 is held in place in a stack-like configuration of aligned electrocaloric film segments by film grabbers 32 and 34. It should be noted here that the particular depiction in FIG. 4 of the film grabbers 32 and 34 is schematic in nature, and that film grabbers or handlers or other apparatus can utilize different configurations known in the film handling art. The temporary supporting structure can be removed after the film is secured in place with spacers, end caps, housing attachments, or other permanent supporting structure.

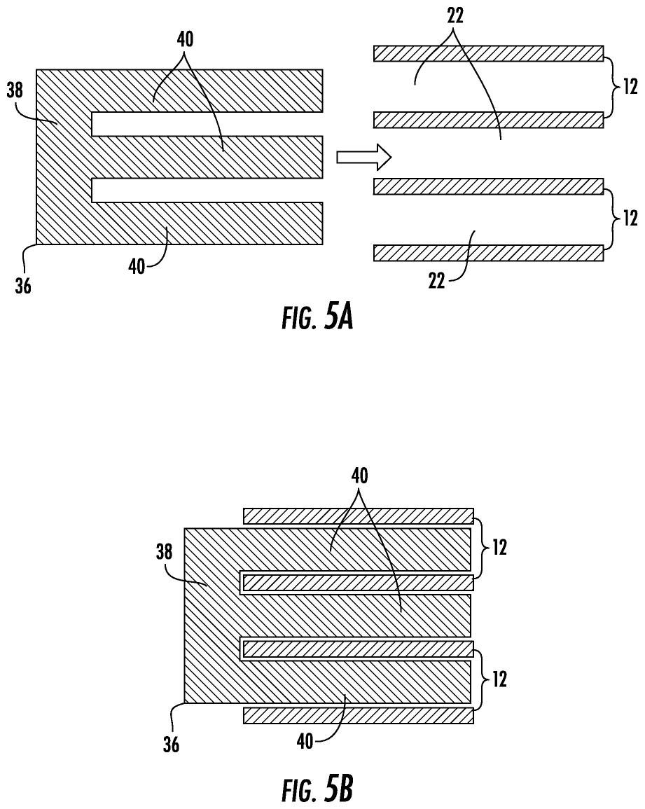

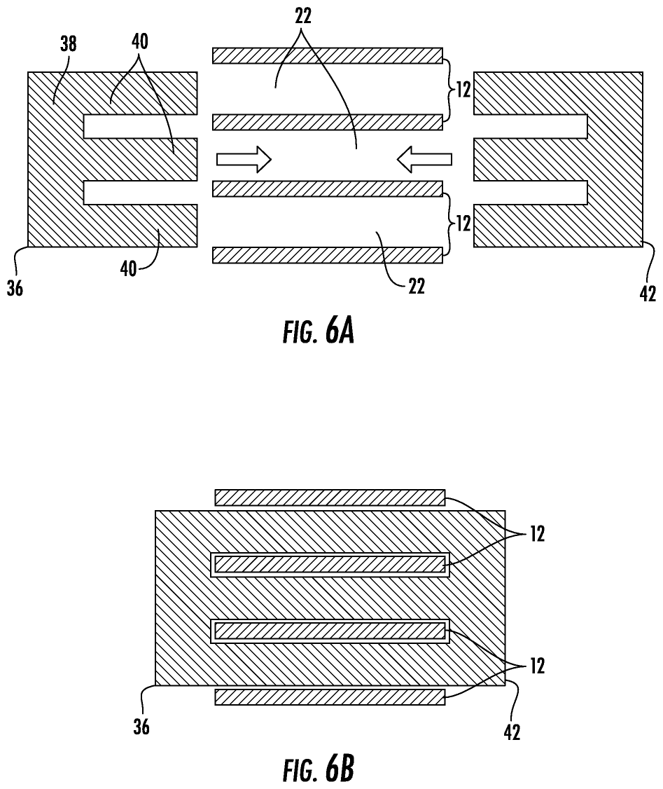

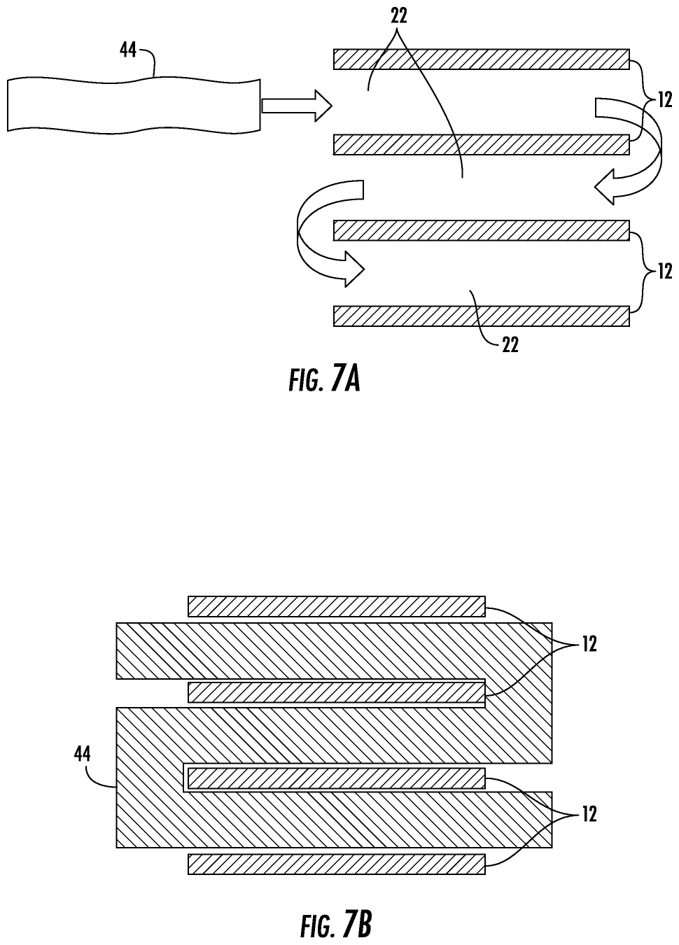

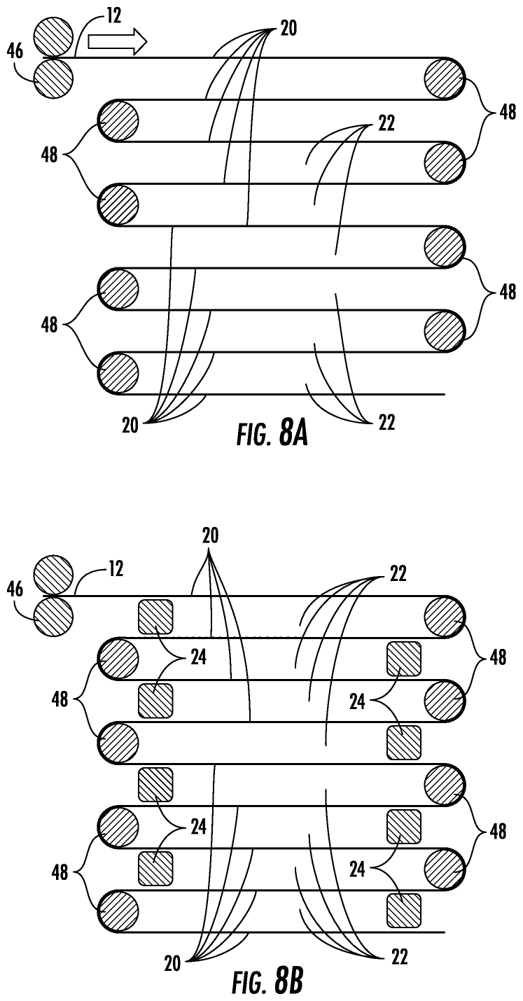

Example embodiments of engagement of spacers with aligned segments of electrocaloric film are shown in FIGS. 5A-5B, FIGS. 6A-6B, and FIGS. 7A-7B, which schematically show insertion or interweaving of spacer(s) between the aligned segments in a side view of the electrocaloric film segment configuration of FIG. 4 (with the film grabbers 32 and 34 not shown, for ease of illustration). As shown in FIG. 5A, a spacer 36 includes a base 38 and a plurality of projections 40 extending from the base 38. This comb-like structure can be engaged with the film segments by inserting the spacer projections 40 into the gaps 22 in the direction of the arrow shown in FIG. 5A, with the engaged spacer shown in FIG. 5B. In some embodiments, a plurality of spacers with a base and projections can be engaged with the film segments. An example embodiment is schematically shown in FIGS. 6A and 6B, in which projections of a first spacer 38 and of a second spacer 42 are inserted into the gaps 22. In some embodiments the projections of the spacers can engage with each other in the gaps 22 as shown in FIG. 6B; however, such engagement is not required and the plurality of spacers can be disposed at different locations (e.g., opposite ends of the stack-like structure) or at angles across the stack different than the direction perpendicular to the direction of extension of the continuous sheet of electrocaloric film 12 as shown in the Figures. As mentioned above, in some embodiments, a continuous spacer can be interwoven between the aligned segments. An example embodiment of a continuous interwoven spacer is shown in FIGS. 7A and 7B, in which a continuous flexible spacer 44 (e.g., a ribbon or wire) is interwoven through the gaps 22 in the direction of the arrows shown in FIG. 7A, with the engaged spacer shown in FIG. 7B.

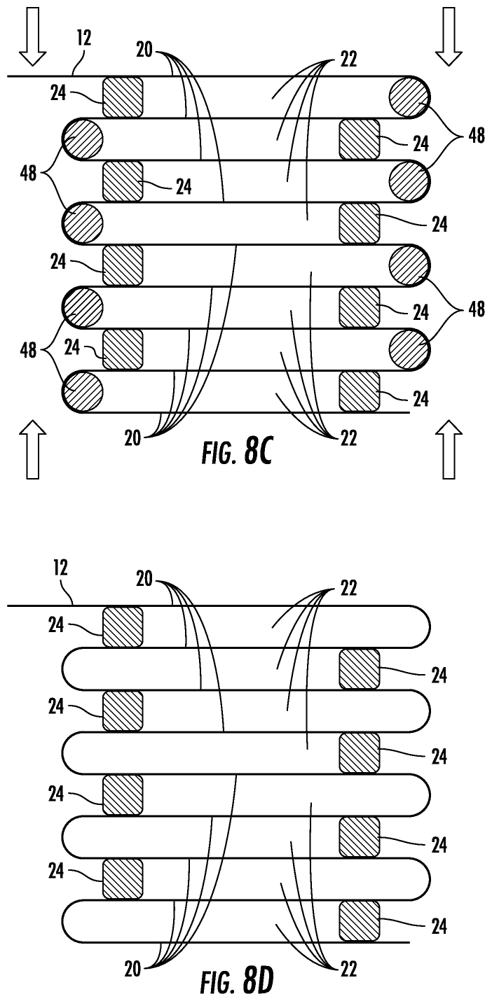

The embodiments disclosed above include bending methods in which folding, including asymmetric folding, can produce a stack-like configuration of connected aligned film segments. In other embodiments, the film can be woven or guided into a stack-like configuration as shown in the example embodiment of FIGS. 8A-8D. As shown in FIG. 8A, an electrocaloric film 12 is dispensed from double roller 46 in the direction of the arrow shown in FIG. 8A and around rollers 48 to form a stack-like configuration of aligned segments 20 and gaps 22. Rollers 48 also provide a temporary support structure until the electrocaloric film is secured in place. In FIG. 8B, spacers 24 are inserted into the gaps 22 using any of the above-described techniques such as insertion of the comb-like structure of spacer 36 (FIGS. 5A-5B). In FIG. 8C, the rollers 48 are moved in the general direction of the arrows as shown to bring the electrocaloric film 12 into contact with the spacers 24 for attachment by adhesive or other attachment. In FIG. 8D, the temporary support structure provided by the rollers 48 is removed, leaving the stack-like configuration of the electrocaloric film secured in place by spacers 24.

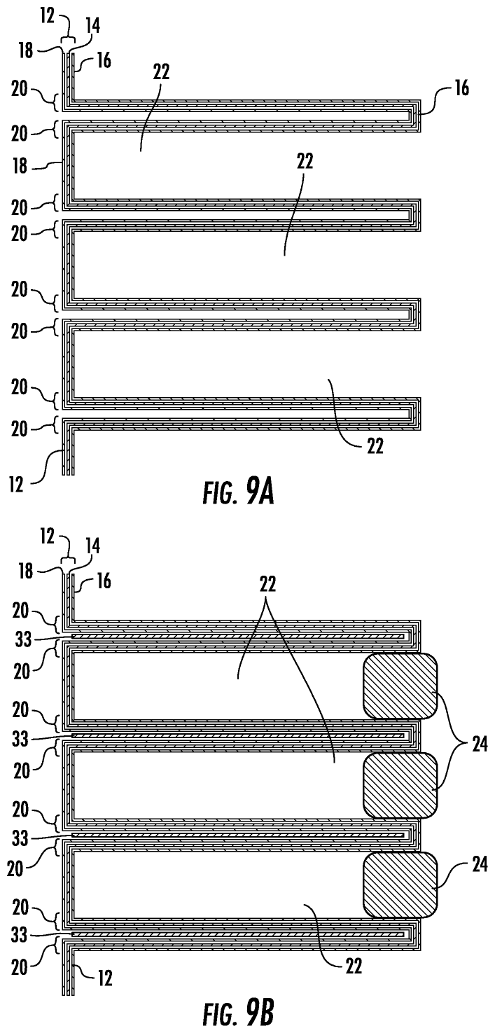

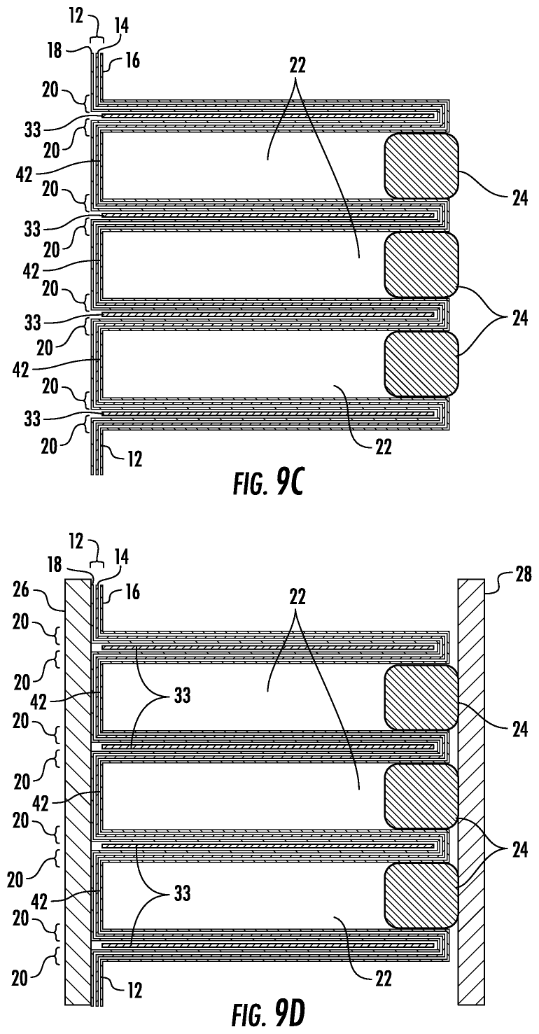

As mentioned above, in some embodiments, a securing method includes attaching an end cap to a plurality of connecting portions of the electrocaloric film between the aligned segments. Such a securing method is schematically shown along with other features in FIGS. 9A-9D, which schematically show fabrication of an electrocaloric article according to FIG. 1. FIG. 9A shows a continuous sheet of electrocaloric film, folded into a stack-like configuration with electrocaloric film segments 20 and gaps 22. The film can be secured in place with a temporary supporting structure, not shown in FIG. 9A but schematically similar to that shown in FIG. 4 or 8A. In addition to the gaps 22 for working fluid flow passages, the asymmetric folding pattern also provides smaller gaps into which supports in the form of planar inserts 33 are disposed. The planar inserts 33 can be inserted after folding as shown in FIG. 9B, or can be put in place during the folding operation. As further shown in FIG. 9B, spacers 24 are inserted into the gaps 22 using any of the above-described techniques such as insertion of the comb-like structure of spacer 36 (FIGS. 5A-5B). In FIG. 9C, an end cap in the form of electrical bus end cap 26 is engaged with connecting portions 42 of the electrocaloric film 12 between the aligned segments 20 to secure the electrocaloric film on the left-hand side of the stack-like configuration with the aligned segments 20. In FIG. 9D, another end cap in the form of in the form of electrical bus end cap 28 is engaged with spacers 24, which have been positioned to extend beyond the connecting portions 44 of the electrocaloric film 12. In some embodiments (e.g., FIG. 1), the spacers 24 can be positioned flush with the connecting portions 44 so that the electrical bus end cap 28 can attach to the spacers 24 and the connecting portions 44. In some embodiments, the spacers can be positioned in the gaps 22 inward from the connecting portions 44 so that the electrical bus end cap 28 can attach to the connecting portions 44 and not to the spacers 24. Attachment of the end caps can be by various techniques such as adhesive. In some embodiments, the end cap can be configured with a well or other recess in which an uncured or partially cured potting compound (e.g., a polyurethane potting compound) is disposed, and the connecting portions 42, spacers 24, or connecting portions 44 can be embedded in the potting composition, which is then cured to form a potted engagement.

The spacers 24, end caps 26/28, or supports 33 can be electrically conductive or electrically non-conductive, depending on system design parameters. As seen in the Figures above, the back and forth bending of the electrocaloric film provides an orientation of the film where the electrodes 16 on the segments 20 face each other across the gaps 22, and the electrodes 14 on the segments 20 face each other across the small gaps into which the supports 33 are inserted in FIG. 9B. With the common electrical potential across the gaps 22, the spacers 24 can be electrically conductive, which can promote uniform distribution of electrical current throughout one or more electrodes at a common voltage. In some embodiments, the spacers 24 can be electrically non-conductive. For example, where the electrocaloric article configuration has electrodes of different voltage facing one another across a gap, the spacers will be electrically non-conductive, and can promote avoidance of short circuits by maintaining the gap between the electrodes of different voltage. Additionally, even in the case of electrodes at a common voltage, a conductive bridge between adjoining electrocaloric film segments may not be needed or desired.

Additionally, the end caps 26 and 28 have been described herein in the context of electrically-conductive electrical bus end cap embodiments in which a common electrical connection is provided to the electrocaloric film electrodes 18/16 disposed on the connecting portions 42/44, or to electrically-conductive spacers 24, or both, for connection to a power circuit and/or electrical ground. However, the end caps 26/28 can also be electrically non-conductive, with the electrical connection routed through a separate electrical bus (not shown) or individual electrical connections (not shown) to electrodes on the electrocaloric film segments 20 or to individual spacers 24. Similarly, the planar inserts 33 can also be electrically conductive or electrically non-conductive.

The spacers 24/36/42/44, end caps 26/28, and supports 33, as well as other components of the electrocaloric article or stack such as housing components, support components, etc., can be made of various materials including but not limited to plastics (e.g., moldable thermoplastics such as polypropylene), ceramics, aerogels, cardboard, fiber composites, or metals. Where electrical conductivity is specified, the component can be made of a conductive material such as metal or an electrically-conductive polymer or composite, or can include a non-conductive substrate such as plastic and an electrically-conductive coating disposed on a surface of the non-conductive substrate. Similarly, where an electrical non-conductive component is specified, the component can be made of a non-conductive material such as a thermoplastic (e.g., polypropylene) or can include an electrically-conductive substrate such as metal and an electrically-conductive coating disposed on a surface of the substrate.

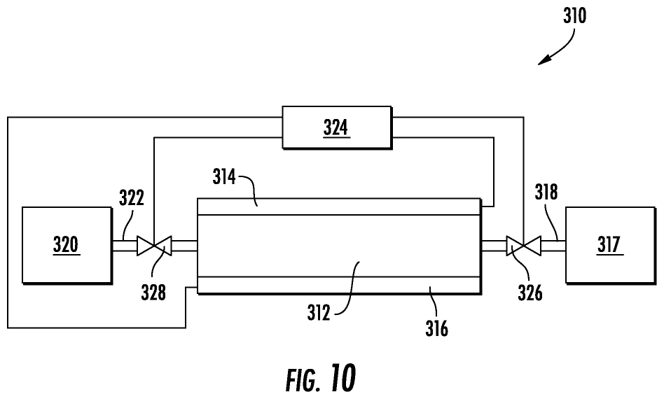

An example embodiment of a heat transfer system and its operation are further described with respect to FIG. 10. As shown in FIG. 10, a heat transfer system 310 comprises a stack 312 of modules with first and second electrical buses 314 and 316 in electrical communication with first and second electrodes on the electrocaloric films. The stack is in thermal communication with a heat sink 317 through a first thermal flow path 318, and in thermal communication with a heat source 320 through a second thermal flow path 322. The thermal flow paths are described below with respect thermal transfer through flow of working fluid through control devices 326 and 328 (e.g., flow dampers) between the stack and the heat sink and heat source. A controller 324 is configured to control electrical current to through a power source (not shown) to selectively activate the buses 314, 316. In some embodiments, the module can be energized by energizing one bus bar/electrode while maintaining the other bus bar/electrode at a ground polarity. The controller 324 is also configured to open and close control devices 326 and 328 to selectively direct the working fluid along the first and second flow paths 318 and 322.

In operation, the system 310 can be operated by the controller 324 applying an electric field as a voltage differential across the electrocaloric films in the stack to cause a decrease in entropy and a release of heat energy by the electrocaloric films. The controller 324 opens the control device 326 to transfer at least a portion of the released heat energy along flow path 318 to heat sink 317. This transfer of heat can occur after the temperature of the electrocaloric films has risen to a threshold temperature. In some embodiments, heat transfer to the heat sink 317 is begun as soon as the temperature of the electrocaloric films increases to be about equal to the temperature of the heat sink 317. After application of the electric field for a time to induce a desired release and transfer of heat energy from the electrocaloric films to the heat sink 317, the electric field can be removed. Removal of the electric field causes an increase in entropy and a decrease in heat energy of the electrocaloric films. This decrease in heat energy manifests as a reduction in temperature of the electrocaloric films to a temperature below that of the heat source 320. The controller 324 closes control device 326 to terminate flow along flow path 318 and opens control device 328 to transfer heat energy from the heat source 320 to the colder electrocaloric films in order to regenerate the electrocaloric films for another cycle.

In some embodiments, for example where a heat transfer system is utilized to maintain a temperature in a conditioned space or thermal target, the electric field can be applied to the electrocaloric films to increase temperature until the temperature reaches a first threshold. After the first temperature threshold, the controller 324 opens control device 326 to transfer heat from the stack to the heat sink 317 until a second temperature threshold is reached. The electric field can continue to be applied during all or a portion of the time period between the first and second temperature thresholds and is then removed to reduce the temperature until a third temperature threshold is reached. The controller 324 then closes control device 326 to terminate heat flow transfer along heat flow path 318 and opens control device 328 to transfer heat from the heat source 320 to the stack. The above steps can be optionally repeated until a target temperature of the conditioned space or thermal target (which can be either the heat source or the heat sink) is reached.

Although any directions described herein (e.g., “up”, “down”, “top”, “bottom”, “left”, “right”, “over”, “under”, etc.) are considered to be arbitrary and to not have any absolute meaning but only a meaning relative to other directions. For convenience, unless otherwise indicated, the terms shall be relative to the view of the Figure shown on the page, i.e., “up” or “top” refers to the top of the page, “bottom” or “under” refers to the bottom of the page, “right” to the right-hand side of the page, and “left” to the left-hand side of the page.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of making an electrocaloric article, comprising:
bending a continuous sheet of an electrocaloric film back and forth to form a plurality of connected aligned segments of electrocaloric film in a configuration that includes gaps between film surfaces of adjacent aligned segments; and
securing the continuous sheet of electrocaloric film in said configuration of connected aligned segments including gaps between film surfaces of adjacent aligned segments with a securing method that includes:
attaching a spacer to the continuous sheet of electrocaloric film prior to the back and forth bending; or
providing a spacer comprising a base and a plurality of projections extending from the base, and inserting the projections into the gaps between the film surfaces of adjacent aligned segments after the back and forth bending; or
interweaving a continuous spacer through said gaps between the aligned segments of the electrocaloric film; or
attaching an end cap to a plurality of connecting portions of the electrocaloric film between the aligned segments.

2. The method of claim 1, wherein the securing method includes attaching the spacer to the continuous sheet of electrocaloric film prior to the back and forth bending.

3. The method of claim 2, wherein the securing method includes dispensing the continuous sheet of electrocaloric film from a roll of electrocaloric film and attaching the spacer to the dispensed electrocaloric film prior to the back and forth bending.

4. (canceled)

5. The method of claim 2, wherein the securing method includes attaching the plurality of spacers to the continuous sheet of electrocaloric film prior to the back and forth bending.

6. The method of claim 1, wherein the securing method includes providing a spacer comprising a base and a plurality of projections extending from the base and inserting the projections into the gaps between the film surfaces of adjacent aligned segments after the back and forth bending.

7. (canceled)

8. The method of claim 6, the securing method includes inserting the projections of a first spacer into the gaps at a first location between the film surfaces at a first edge of a plurality of adjacent aligned segments, inserting the projections of a second spacer into the gaps at a second location between the film surfaces at a second edge of a plurality of adjacent aligned segments opposite the first edge, and engaging the projections of the first and second spacer structures.

9. The method of claim 1, wherein the securing method includes interweaving a continuous spacer through said gaps between the aligned segments of the electrocaloric film.

10. (canceled)

11. The method of claim 1, wherein the securing method includes attaching an end cap to a plurality of connecting portions of the electrocaloric film between the aligned segments.

12. The method of claim 11, wherein the end cap is electrically conductive and is electrically connected to an electrode on the electrocaloric film.

13. The method of claim 11, wherein attaching the end cap to the plurality of connecting portions of the electrocaloric film includes fusing, potting, or molding the end cap to the electrocaloric film.

14. The method of claim 1, wherein the spacer is electrically non-conductive.

15. The method of claim 1, wherein the spacer is electrically conductive.

16. The method of claim 1, further comprising connecting an electrode or electrodes on the electrocaloric film to a power control circuit.

17. The method of claim 16, wherein the spacer is electrically conductive and is electrically connected to the electrode and the power control circuit.

18. The method of claim 16, wherein the electrode or the electrically-conductive spacer is electrically connected to the power control circuit through an electrical bus.

19. The method of claim 1, wherein the bending of the continuous sheet of electrocaloric film imparts the configuration of connected aligned segments with alternating large and small gaps.

20. The method of claim 19, further comprising disposing a support in said small gaps.

21. The method of claim 1, wherein bending the continuous sheet of electrocaloric film includes engaging the electrocaloric film with a supporting structure to position or maintain the electrocaloric film in the configuration comprising aligned segments, and wherein the electrocaloric film is disengaged from the supporting structure after performing the securing method.

22. The method of claim 1, further comprising pre-folding the electrocaloric film prior to bending back and forth to form the plurality of connected aligned segments.

23. A heat transfer system, comprising
a plurality of supported electrocaloric film segments arranged and secured in a stack, prepared according to the method of claim 1;
a working fluid flow path through the stack, said working fluid flow path disposed in gaps between adjacent aligned electrocaloric film segments, said working fluid flow path in operative thermal communication with a heat sink and a heat source at opposite ends of the working fluid flow path;
a plurality of electrodes arranged to generate an electric field in the electrocaloric film segments and connected to a power source configured to selectively apply voltage to activate the electrodes in coordination with fluid flow along the working fluid flow path to transfer heat from the heat source to the heat sink.
